(19) United States
(12) Patent Application Publication
(10) Pub. No.: US 2012/0013571 A1
(43) Pub. Date: Jan. 19, 2012

(54) THREE-DIMENSIONAL TOUCH SENSOR

(75) Inventors: I-HAU YEH, TAIPEI CITY (TW); TIEN-WEN PAO, HSINCHU COUNTY (TW); CHIEN-HUI WU, TAINAN CITY (TW); TA-FAN HSU, NEW TAIPEI CITY (TW)

(73) Assignee: ELAN MICROELECTRONICS CORPORATION, HSINCHU (TW)

(21) Appl. No.: 13/179,743

(22) Filed: Jul. 11, 2011

Related U.S. Application Data
(60) Provisional application No. 61/365,019, filed on Jul. 16, 2010.

(51) Int. Cl. G06F 3/044

(52) U.S. Cl. 345/174; 178/18.06

(57) ABSTRACT

A three-dimensional touch sensor is constructed from a two-dimensional capacitive touch sensor in association with a conductive layer and an elastic insulator or with an insulation layer and an elastic conductor. When the three-dimensional touch sensor is touched, the two-dimensional capacitive touch sensor positions the touch point in a sensing plane, and the elastic insulator or the elastic conductor deforms responsive to the pressure and thus generates a capacitance variation, from which a sensing value in the perpendicular direction is derived related to the magnitude of the pressure.

### REFERENCE TO RELATED APPLICATION

This Application is based on Provisional Patent Application Ser. No. 61/365,019, filed 16 Jul. 2010, currently pending.

### FIELD OF THE INVENTION

The present invention is related generally to a touch sensor and, more particularly, to a three-dimensional touch sensor.

### BACKGROUND OF THE INVENTION

The capacitive touch pad operates with a touch sensor to generate capacitance variations when touched by an object such as a finger or another conductor, and identify the touch point of the object from the capacitance variations. A conventional capacitive touch pad is only capable of one-dimensional or two-dimensional positioning, and may accomplish more functions if in association with detection of gestures such as tapping, double tapping, dragging and circling. Another approach to expand functions is to detect the touched area to determine the pressure applied to the capacitive touch pad. However, different users and/or different fingers result in different touched areas, and thus this indirect pressure detection can not provide wide applications. An alternative solution is to provide additional keys/buttons. Nevertheless, the addition of physical components not only undesirably increases the volume and manufacturing costs of the products, but also complicates the users' operation.

Therefore, it is desired a three-dimensional touch sensor capable of directly detecting a touched pressure.

### SUMMARY OF THE INVENTION

An objective of the present invention is to provide a three-dimensional touch sensor.

A further objective of the present invention is to provide applications of a three-dimensional touch sensor.

According to the present invention, a three-dimensional touch sensor includes a two-dimensional capacitive touch sensor, a first conductive layer and a second conductive layer below the two-dimensional capacitive touch sensor, and an elastic insulator between the first and second conductive layers. The first and second conductive layers and the elastic insulator therebetween establish a variable capacitor. When the three-dimensional touch sensor is touched, the elastic insulator will be deformed due to being pressed, which reduces the distance between the first and second conductive layers, thereby generating a capacitance variation, from which a sensing value related to the pressure's magnitude can be derived.

According to the present invention, a three-dimensional touch sensor includes a two-dimensional capacitive touch sensor, a conductive layer below the two-dimensional capacitive touch sensor, an insulation layer below the conductive layer, and an elastic conductor below the insulation layer. The conductive layer, the insulation layer and the elastic conductor establish a variable capacitor. When the three-dimensional touch sensor is touched, the elastic conductor will be defamed due to being pressed, which enlarges the contact area between itself and the insulation layer, thereby generating a capacitance variation, from which a sensing value related to the pressure's magnitude can be derived.

According to the present invention, a three-dimensional touch sensor includes a two-dimensional capacitive touch sensor, an insulation layer below the two-dimensional capacitive touch sensor, and an elastic conductor below the insulation layer. The two-dimensional capacitive touch sensor, the insulation layer and the elastic conductor establish a variable capacitor. When the three-dimensional touch sensor is touched, the elastic conductor will be deformed due to being pressed, which enlarges a contact area between itself and the insulation layer, thereby generating a capacitance variation, from which a sensing value related to the pressure's magnitude can be derived.

According to the present invention, a three-dimensional touch sensor includes a two-dimensional capacitive touch sensor, an insulation layer on the two-dimensional capacitive touch sensor, and an elastic conductor on the insulation layer. The two-dimensional capacitive touch sensor, the insulation layer and the elastic conductor establish a variable capacitor. When the three-dimensional touch sensor is touched, the elastic conductor will be deformed due to being pressed, which enlarges the contact area between itself and the insulation layer, thereby generating a capacitance variation, from which a sensing value related to the pressure's magnitude can be derived.

According to the present invention, a three-dimensional touch sensor is constructed from a two-dimensional capacitive touch sensor in association with a conductive layer and an elastic insulator or with an insulation layer and an elastic conductor, a region is defined on the two-dimensional capacitive touch sensor, a touch point in a sensing plane is positioned by the two-dimensional capacitive touch sensor, a capacitance variation is generated from a deformation of the elastic insulator or the elastic conductor responsive to a pressure, from the capacitance variation is generated a sensing value in a perpendicular direction, which is related to the pressure in magnitude, and a corresponding command is generated if the touch point is in the defined region and the sensing value is greater than a threshold.

According to the present invention, a three-dimensional touch sensor is constructed from a two-dimensional capacitive touch sensor in association with a conductive layer and an elastic insulator or with an insulation layer and an elastic conductor, an original point is defined on the two-dimensional capacitive touch, a touch point in a sensing plane is positioned by the two-dimensional capacitive touch sensor, a capacitance variation is generated from a deformation of the elastic insulator or the elastic conductor responsive to a pressure, from the capacitance variation is generated a sensing value in a perpendicular direction, which is related to the pressure in magnitude, a vector from the original point to the touch point is used to define a moving direction of a controlled subject, and the sensing value is used to define a moving parameter of the controlled subject.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a schematic diagram showing a first embodiment of a three-dimensional touch sensor according to the present invention;

FIG. 2 is a schematic diagram showing a second embodiment of a three-dimensional touch sensor according to the present invention;

FIG. 3 is a schematic diagram showing a third embodiment of a three-dimensional touch sensor according to the present invention;

FIG. 4 is a schematic diagram showing a fourth embodiment of a three-dimensional touch sensor according to the present invention;

FIG. 5 depicts a sensing plane of a two-dimensional capacitive touch sensor;

FIG. 6 is a schematic diagram showing a first application of a three-dimensional touch sensor according to the present invention; and

FIG. 7 is a schematic diagram showing a second application of a three-dimensional touch sensor according to the present invention.

### DETAILED DESCRIPTION OF THE INVENTION

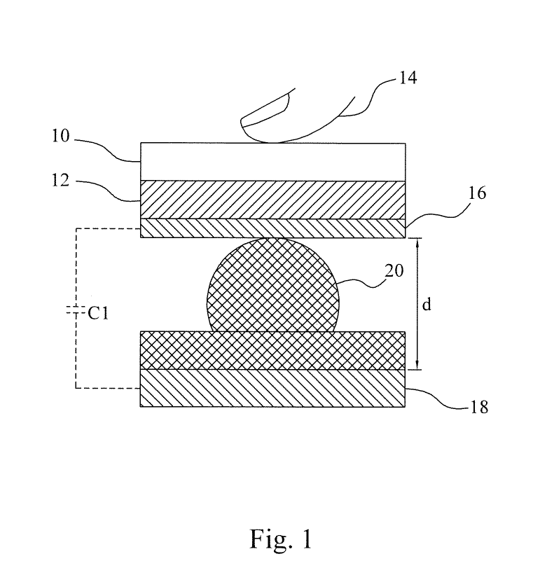

FIG. 1 is a schematic diagram showing a first embodiment of a three-dimensional touch sensor according to the present invention, which includes a protective layer 10, a two-dimensional capacitive touch sensor 12, conductive layers 16 and 18, and an elastic insulator 20. The protective layer 10 is deposited on the two-dimensional capacitive touch sensor 12. As is well known, the two-dimensional capacitive touch sensor 12 has a plurality of sensing electrodes, and when a conductor 14 (e.g. a finger) touches the protective layer 10, the sensing electrodes in the touched area will generate capacitance variations, from which the location of the conductor 14 on the sensing plane can be determined. This disclosure refers the term “sensing plane” to a plane defined by all the sensing electrodes of the two-dimensional capacitive touch sensor 12, for example, in FIG. 1, the top surface of the two-dimensional capacitive touch sensor 12, i.e. the one perpendicular to the paper where the drawing is presented, is the sensing plane. Some conventional capacitive touch pads have a conductive layer below its touch sensor to shield off noises coming from the circuit therebeneath, thereby securing the touch sensor from interference. In this embodiment, the conductive layer designed for shielding off noises may be used as the conductive layer 16, below which the conductive layer 18 and the elastic insulator 20 are added and the elastic insulator 20 is sandwiched between and separate the conductive layers 16 and 18 by a distance d, thereby establishing a variable capacitor having a capacitance

$$C 1 ∝ \frac{A}{d} , \qquad [ Eq \text{-} 1 ]$$

where A is the area in which the two conductive layers 16 and 18 overlap each other. Applying a pressure will deform the elastic insulator 20 and thus change the distance d between the conductive layers 16 and 18. The greater the pressure is, the smaller the distance is. According to the equation Eq-1, the variable capacitance C1 increases as the distance d decreases. Therefore, sensing the capacitance variation of the variable capacitor C1 gives the sensing result associated with the magnitude of the pressure, namely the sensing result being the sensing value associated to the perpendicular direction. This disclosure refers the term “perpendicular direction” to the direction perpendicular to the sensing plane, for example, in FIG. 1, the perpendicular direction is the one parallel to the distance d. Preferably, the elastic insulator 20 includes a deformable spherical part contacting the conductive layer 16.

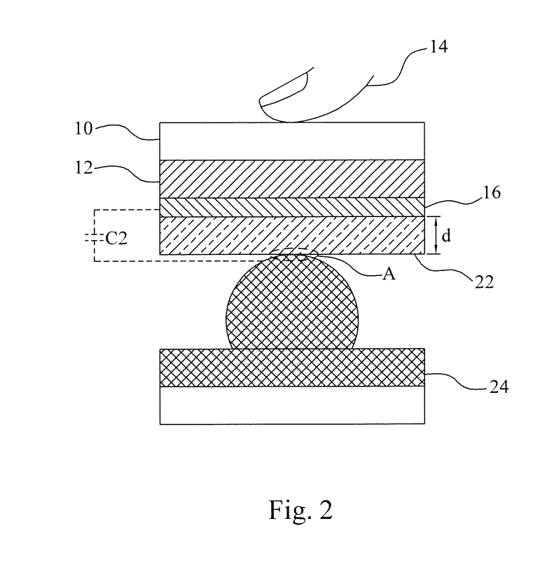

FIG. 2 is a schematic diagram showing a second embodiment of a three-dimensional touch sensor according to the present invention, in which an insulation layer 22 and an elastic conductor 24 are additionally provided below the conductive layer 16, and the insulation layer 22 is sandwiched between the conductive layer 16 and the elastic conductor 24 such that the conductive layer 16 and the elastic conductor 24 are separated by a distance d. Preferably, the elastic conductor 24 has a spherical part contacting the insulation layer 22 in a contact area A, so that the conductive layer 16 and the elastic conductor 24 establish a variable capacitor C2. Pressing the conductor 14 downward leads to the deformation of the elastic conductor 24, and in turn changes the contact area A between the elastic conductor 24 and the insulation layer 22 in size. The greater the pressure is, the larger the contact area A is. According to the equation Eq-1, the variable capacitor C2 has its capacitance varying with the variation of the contact area A, and thus sensing the capacitance variation of the variable capacitor C2 can give a pressure-related sensing value, namely a sensing value in the perpendicular direction. The number, shape and distribution of the elastic conductor 24 depend on demand, for example for accuracy. In one embodiment, the elastic conductor 24 has a deformable spherical part contact the conductive layer 22.

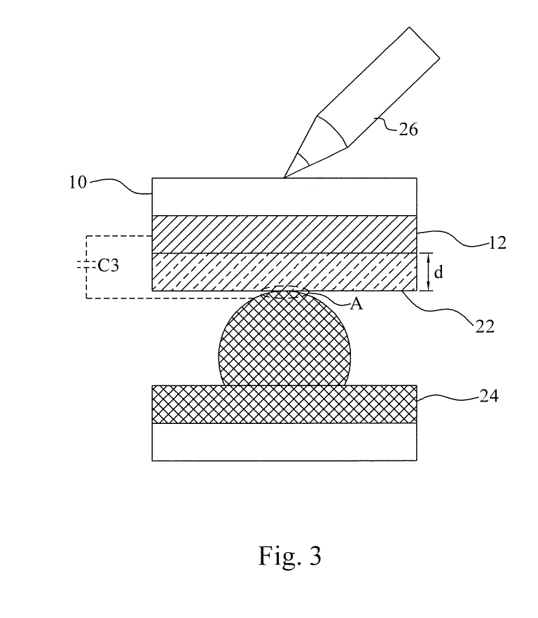

FIG. 3 is a schematic diagram showing a third embodiment derived from FIG. 2 by removing the conductive layer 16 and using the sensing electrode of the two-dimensional capacitive touch sensor 12 as an electrode of a variable capacitor C3. Similarly, the insulation layer 22 is sandwiched between and thereby separates the two-dimensional capacitive touch sensor 12 and the elastic conductor 24 by a distance d. The elastic conductor 24 contacts the insulation layer 22 in an area A with its spherical part, so that the elastic conductor 24 and the sensing electrode of the two-dimensional capacitive touch sensor 12 establish the variable capacitor C3. The contact area A varies with the pressure applied by an object 26 in the manner that the greater the pressure is, the larger the contact area A is. According to the equation Eq-1, the variable capacitor C3 has its capacitance varies with the variation of the contact area A, and thus the capacitance variation sensed from the sensing electrodes of the two-dimensional capacitive touch sensor 12 can be used for positioning, and the capacitance variation of the variable capacitor C3 can be used as the sensing value in the perpendicular direction. In this embodiment, even if the object 26 is non-conductive, it still can change the contact area A in size, thereby contributing to the desired positioning through changing the sensing value obtained by the two-dimensional capacitive touch sensor 12. In another embodiment, the protective layer 10 is design to have a thickness sufficiently large to minimize the impact of a conductive object 26 on the variable capacitor C3.

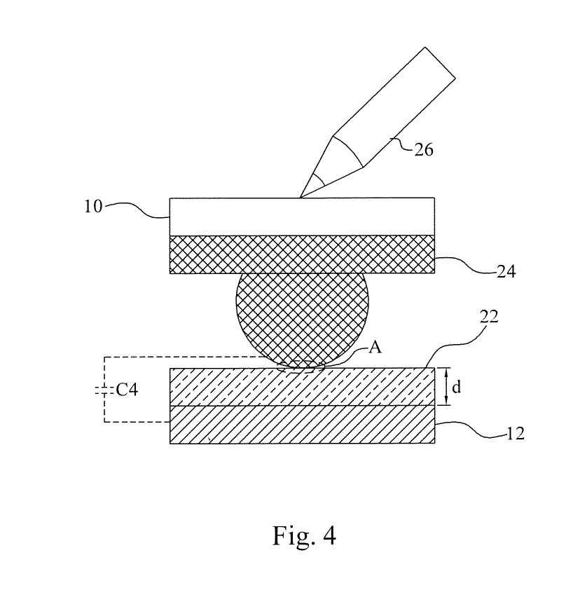

Reversely ordering the components of FIG. 3 becomes a fourth embodiment as shown in FIG. 4, in which the elastic conductor 24 is below the protective layer 10, and the two-dimensional capacitive touch sensor 12 is on the bottom. Similarly, the insulation layer 22 separates the elastic conductor 24 from the two-dimensional capacitive touch sensor 12, and the elastic conductor 24 has its spherical part contacting the insulation layer 22 in the area A, so that the elastic conductor 24 and the sensing electrode of the two-dimensional capacitive touch sensor 12 establish a variable capacitor C4. In this embodiment, the distance d is fixed, while the contact area A varies with the pressure applied by the object 26 in the manner that the greater the pressure is, the larger the contact area A is. According to the equation Eq-1, the variable capacitor C4 has its capacitance varies with the variation of the contact area A, and thus sensing the capacitance variation of the variable capacitor C4 dives a pressure-related sensing value, namely a sensing value in the perpendicular direction. As described above for the embodiment of FIG. 3, in this embodiment, a non-conductive object 26 still can change the contact area A, thereby achieving the positioning function through the sensing value obtained by the two-dimensional capacitive touch sensor 12.

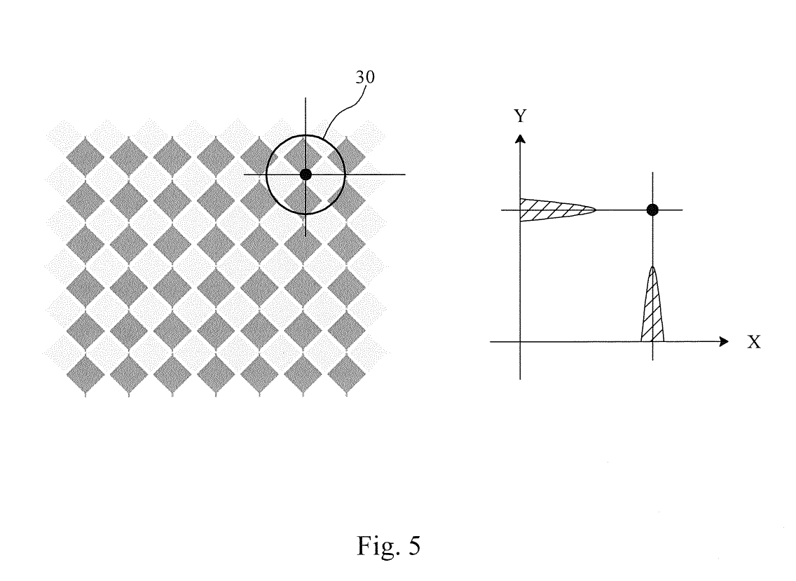

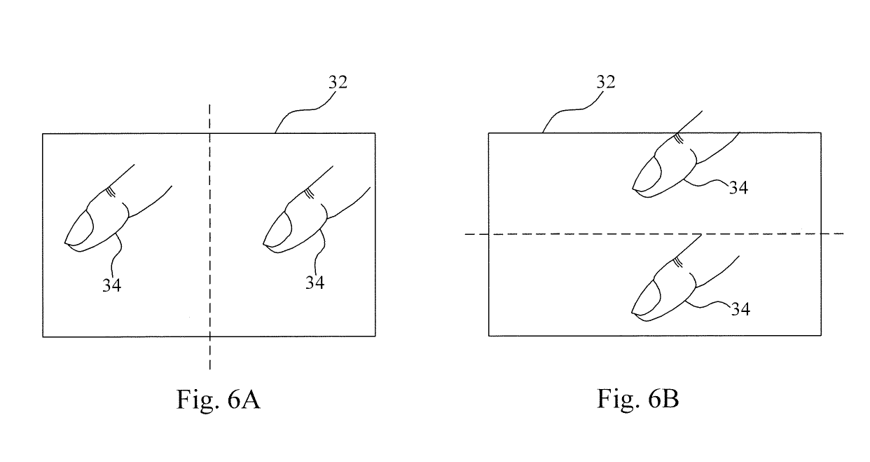

The sensing electrodes of the two-dimensional capacitive touch sensor 12 may have any of various shapes and layouts. For example, the right part of FIG. 5 presents a common pattern, wherein the sensing plane is constructed from a plurality of sensing electrodes extending in an X direction and a plurality of sensing electrodes extending in a Y direction. When a single touch or a multi-touch is applied, the affected sensing electrodes will generate capacitance variations, from which the location of the touch point 30 can be determined. In some other embodiments, by sensing the variation of self capacitance of the sensing electrodes in the X or Y direction, or by sensing the variation of mutual capacitance of the sensing electrodes between the X and Y directions, a touch point can be determined. In addition, when the sensing value in the perpendicular direction is considered as well, different applications can be achieved. For example, one or more regions may be defined on the two-dimensional capacitive touch sensor 12, so that when the sensing value in the perpendicular direction exceeds a threshold, one or more commands preset and associated with the regions will be given according to which region(s) the touch point 30 is in. For example, referring to FIG. 6A, when an object 34 applies a pressure exceeding the threshold to the left half of the three-dimensional touch sensor 32, a command representative of “selection” is generated, whereas when an object 34 applies a pressure exceeding the threshold to the right half of the three-dimensional touch sensor 32, a command representative of “menu” is generated. A further example is illustrated with reference to FIG. 6B. When browsing with a window on a display, a pressure exceeding a threshold applied by an object 34 to the upper half of the three-dimensional touch sensor 32 will trigger a command representative of “scrolling up,” and a pressure exceeding a threshold applied by an object 34 to the lower half of the three-dimensional touch sensor 32 will trigger a command representative of “scrolling down.” The thresholds designed for different defined regions may be identical or different.

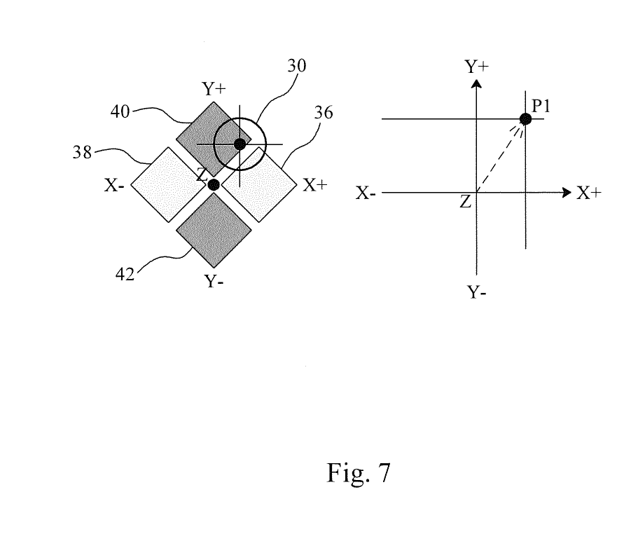

A three-dimensional touch sensor according to the present invention may be used to control a subject on a screen, such as a cursor or a character in a game displayed on the screen. In an application, an original point is defined on the two-dimensional capacitive touch sensor 12, the two-dimensional capacitive touch sensor 12 positions a touch point, a vector from the original point to the touch point is used to define the moving direction of a controlled subject, and the sensing value in the perpendicular direction is used to scale the movement of the controlled subject in terms of, for example, distance or speed. In some other embodiments, by detecting the variation of the self capacitance of the sensing electrodes in the X or Y direction, or by detecting the variation of the mutual capacitance of the sensing electrodes in the X and Y directions, a touch point can be positioned. For example, referring to FIG. 7, the two-dimensional capacitive touch sensor 12 employs only four independent electrodes 36, 38, 40 and 42, with an original point Z defined as coinciding its center and the electrodes 36, 38, 40 and 42 representing the moving directions X+, X−, Y+or Y− in the sensing plane respectively, as shown clearly in the coordinate system at the right part of FIG. 7. When an object 30 is between the electrodes 36 and 40, the position P1 of the object 30 can be determined by using applicable algorithms to perform calculation based upon the sensing values of the two-dimensional capacitive touch sensor 12. Meanwhile, the pressure applied by the object 30 to the three-dimensional touch sensor generates a sensing value in the perpendicular direction. Then the vector from the original point Z to the position P1 is identified for the moving direction of the subject and the sensing value in the perpendicular direction is identified for the moving parameter, according to which the cursor or the game character on the screen is moved. This application is advantageous because it provides the possibility of further downsizing the area of a touch control device.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A three-dimensional touch sensor comprising:
a two-dimensional capacitive touch sensor;
a first conductive layer and a second conductive layer both below the two-dimensional capacitive touch sensor; and
an elastic insulator sandwiched between the first and second conductive layers to establish a variable capacitor,
wherein the elastic insulator deforms responsive to a pressing, and thus changes a distance between the first and second conductive layers, thereby causing a capacitance variation of the variable capacitor.

2. The three-dimensional touch sensor of claim 1, further comprising a protective layer deposited on the two-dimensional capacitive touch sensor.

3. The three-dimensional touch sensor of claim 1, wherein the elastic insulator comprises a deformable spherical part contacting the first conductive layer.

4. A three-dimensional touch sensor comprising:
a two-dimensional capacitive touch sensor;
a conductive layer below the two-dimensional capacitive touch sensor;
an insulation layer below the conductive layer; and
an elastic conductor below the insulation layer to establish a variable capacitor;
wherein the elastic insulator deforms responsive to a pressing, and thus changes a contact area between itself and the insulation layer, thereby causing a capacitance variation of the variable capacitor.

5. The three-dimensional touch sensor of claim 4, further comprising a protective layer deposited on the two-dimensional capacitive touch sensor.

6. The three-dimensional touch sensor of claim 4, wherein the elastic conductor is shaped arbitrarily.

7. The three-dimensional touch sensor of claim 6, wherein the elastic conductor comprises a deformable spherical part contacting the insulation layer.

8. A three-dimensional touch sensor comprising:
a two-dimensional capacitive touch sensor;
an insulation layer below the two-dimensional capacitive touch sensor; and
an elastic conductor below the insulation layer to establish a variable capacitor;
wherein the elastic conductor deforms responsive to a pressing, and thus changes a contact area between itself and the insulation layer, thereby causing a capacitance variation of the variable capacitor.

9. The three-dimensional touch sensor of claim 8, further comprising a protective layer deposited on the two-dimensional capacitive touch sensor.

10. The three-dimensional touch sensor of claim 8, wherein the elastic conductor is shaped arbitrarily.

11. The three-dimensional touch sensor of claim 10, wherein the elastic conductor comprises a deformable spherical part contacting the insulation layer.

12. A three-dimensional touch sensor comprising:
a two-dimensional capacitive touch sensor;
an insulation layer on the two-dimensional capacitive touch sensor; and
an elastic conductor on the insulation layer to establish a variable capacitor;
wherein the elastic conductor deforms responsive to a pressing, and thus changes a contact area between itself and the insulation layer, thereby causing a capacitance variation of the variable capacitor.

13. The three-dimensional touch sensor of claim 12, further comprising a protective layer deposited on the elastic conductor.

14. The three-dimensional touch sensor of claim 12, wherein the elastic conductor is shaped arbitrarily.

15. The three-dimensional touch sensor of claim 14, wherein the elastic conductor comprises a deformable spherical part contacting the insulation layer.

16. An application of a three-dimensional touch sensor constructed from a two-dimensional capacitive touch sensor in association with a conductive layer and an elastic insulator or with an insulation layer and an elastic conductor, the application comprising the steps of:
defining a region on the two-dimensional capacitive touch sensor;
positioning a touch point in a sensing plane by the two-dimensional capacitive touch sensor;
generating a capacitance variation from a deformation of the elastic insulator or the elastic conductor responsive to a pressuring, and deriving a sensing value in a perpendicular direction from the capacitance variation that is related to a pressure of the pressing; and
generating a corresponding command if the touch point is in the region and the sensing value is greater than a threshold.

17. The application of claim 16, wherein the step of positioning a touch point in a sensing plane by the two-dimensional capacitive touch sensor comprises the step of detecting a variation of a self capacitance or a mutual capacitance of the two-dimensional capacitive touch sensor.

18. An application of a three-dimensional touch sensor constructed from a two-dimensional capacitive touch sensor in association with a conductive layer and an elastic insulator or with an insulation layer and an elastic conductor, the application comprising the steps of:
defining an original point on the two-dimensional capacitive touch sensor;
positioning a touch point in a sensing plane by the two-dimensional capacitive touch sensor;
generating a capacitance variation from a deformation of the elastic insulator or the elastic conductor responsive to a pressuring, and deriving a sensing value in a perpendicular direction from the capacitance variation that is related to the pressure of the pressing; and
defining a moving direction of a controlled subject with a vector from the original point to the touch point, and defining a moving parameter of the controlled subject with the sensing value.

19. The application of claim 18, wherein the moving parameter is a distance for the controlled subject to move.

20. The application of claim 18, wherein the moving parameter is a speed for the controlled subject to move.

21. The application of claim 18, wherein the step of positioning a touch point in a sensing plane by the two-dimensional capacitive touch sensor comprises the step of detecting a variation of a self capacitance or a mutual capacitance of the two-dimensional capacitive touch sensor.
